(19) United States
(12) Patent Application Publication
(10) Pub. No.: US 2026/0031845 A1
(43) Pub. Date: Jan. 29, 2026

(54) Receiving module of transmission interface

(71) Applicant: REALTEK SEMICONDUCTOR CORPORATION, Hsinchu (TW)

(72) Inventor: SHIH-HSIUNG HUANG, Hsinchu (TW)

(21) Appl. No.: 19/260,803

(22) Filed: Jul. 7, 2025

(30) Foreign Application Priority Data
Jul. 26, 2024 (TW) 113127991

(51) Int. Cl. H04B 1/16; H04B 1/00

(52) U.S. Cl. CPC H04B 1/1607; H04B 1/0075; H04B 1/1638

(57) ABSTRACT

A receiving module of a transmission interface includes an analog front-end (AFE) circuit and a track-and-hold circuit. The AFE circuit receives an input signal to generate a first intermediate signal. The track-and-hold circuit samples the first intermediate signal according to a first clock to generate a second intermediate signal, and comprises at least one first switch, at least one second switch, at least one first capacitor, and at least one second capacitor. The first and second switches are turned on or off according to the first clock. The first capacitor has first and second terminals. The first terminal is coupled to the AFE circuit. The second terminal receives a second clock. The second capacitor has third and fourth terminals. The third terminal is coupled to the AFE circuit. The fourth terminal receives the second clock. The first clock and the second clock are inverted signals of each other.

### BACKGROUND OF THE INVENTION

### 1. Field of the Invention

The present invention generally relates to a transmission interface, and more particularly, to a receiving module of the transmission interface.

### 2. Description of Related Art

The integrated circuits (ICs) of conventional high-speed transmission interfaces (e.g., the High-Definition Multimedia Interface (HDMI), the Universal Serial Bus (USB), etc.) usually include a continuous time linear equalizer (CTLE) and a variable gain amplifier (VGA). The CTLE is used to provide a high-frequency gain to compensate for the high-frequency signal gain loss. The VGA is used to provide adjustments for multiple gain settings. CTLE and VGA are well known to people having ordinary skill in the art, so further elaboration is omitted for brevity.

The output terminal of the CTLE or VGA is coupled to a sampling switch and an analog-to-digital converter (ADC). The sampling switch operates according to a sampling clock. The sampled signal (discrete-time analog signal) outputted by the sampling switch is first converted by the ADC to form a digital signal and then processed by the digital circuit connected to the ADC.

The disadvantage of conventional high-speed transmission interfaces is that the sampling clock of the sampling switch causes disturbance to the output of the preceding stage (the CTLE or the VGA) through the parasitic capacitor of the sampling switch, affecting the overall performance of the IC.

### SUMMARY OF THE INVENTION

In view of the issues of the prior art, an object of the present invention is to provide a receiving module of a transmission interface, so as to make an improvement to the prior art.

According to one aspect of the present invention, a receiving module of a transmission interface is provided. The receiving module includes an analog front-end (AFE) circuit that receives an input signal to generate a first intermediate signal, and a track-and-hold circuit that is coupled to the AFE circuit and samples the first intermediate signal according to a first clock to generate a second intermediate signal. The track-and-hold circuit includes at least one first switch coupled to the AFE circuit and turned on or off according to the first clock, at least one second switch coupled to the AFE circuit and turned on or off according to the first clock, at least one first capacitor with a first terminal and a second terminal where the first terminal is coupled to the AFE circuit and the second terminal receives a second clock, and at least one second capacitor with a third terminal and a fourth terminal where the third terminal is coupled to the AFE circuit and the fourth terminal receives the second clock. The first clock and the second clock are each other's inverted signals.

According to another aspect of the present invention, a receiving module of a transmission interface provided. The receiving module includes an analog front-end (AFE) circuit that receives an input signal to generate a first intermediate signal, and an analog-to-digital converter (ADC) coupled to the AFE circuit. The ADC includes a track-and-hold circuit that samples the first intermediate signal according to a first clock to generate a sampled signal, and a conversion circuit that is coupled to the track-and-hold circuit and converts the sampled signal into a digital signal. The track-and-hold circuit includes at least one first switch coupled to the AFE circuit and turned on or off according to the first clock, at least one second switch coupled to the AFE circuit and turned on or off according to the first clock, at least one first capacitor with a first terminal and a second terminal where the first terminal is coupled to the AFE circuit and the second terminal receives a second clock, and at least one second capacitor with a third terminal and a fourth terminal where the third terminal is coupled to the AFE circuit and the fourth terminal receives the second clock. The first clock and the second clock are each other's inverted signals.

The technical means embodied in the embodiments of the present invention can solve at least one of the problems of the prior art. Therefore, compared to the prior art, the present invention can reduce the disturbance from the sampling clock.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is a functional block diagram of the receiving module of a transmission interface according to an embodiment of the present invention.

FIG. 2 is a functional block diagram of the receiving module of a transmission interface according to another embodiment of the present invention.

FIG. 3 is a circuit diagram of the track-and-hold circuit according to an embodiment of the present invention.

FIG. 4 is a circuit diagram of the track-and-hold circuit according to another embodiment of the present invention.

FIG. 5 is a circuit diagram of the track-and-hold circuit according to another embodiment of the present invention.

FIG. 6 is a circuit diagram of the track-and-hold circuit according to another embodiment of the present invention.

FIG. 7 shows the waveforms of the clocks according to an embodiment of the present invention.

FIG. 8 shows the waveforms of the clocks according to another embodiment of the present invention.

FIG. 9 is a functional block diagram of the analog front-end (AFE) circuit according to an embodiment of the present invention.

FIG. 10 is a functional block diagram of the AFE circuit according to another embodiment of the present invention.

FIG. 11 is a functional block diagram of the AFE circuit according to another embodiment of the present invention.

FIG. 12 is a functional block diagram of the AFE circuit according to another embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a receiving module of a transmission interface. On account of that some or all elements of the receiving module of a transmission interface could be known, the detail of such elements is omitted provided that such detail has little to do with the features of this disclosure, and that this omission nowhere dissatisfies the specification and enablement requirements. A person having ordinary skill in the art can choose components or steps equivalent to those described in this specification to carry out the present invention, which means that the scope of this invention is not limited to the embodiments in the specification.

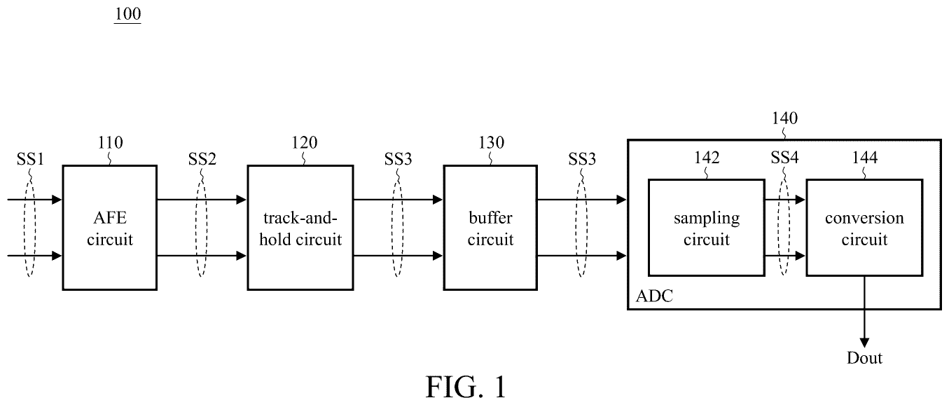

Reference is made to FIG. 1, which is a functional block diagram of a receiving module of a transmission interface according to an embodiment of the present invention. The receiving module 100 of a transmission interface includes an analog front-end (AFE) circuit 110, a track-and-hold circuit 120, a buffer circuit 130, and an analog-to-digital converter (ADC) 140, all of which are coupled to each other.

The AFE circuit 110 receives an input signal SS1 to generate a first intermediate signal SS2.

The track-and-hold circuit 120 samples the first intermediate signal SS2 to generate a second intermediate signal SS3.

The buffer circuit 130 is used to enhance the driving capability of the second intermediate signal SS3. In some embodiments, the buffer circuit 130 can be embodied by an inverter or a source follower. In other embodiments, the driving capability of the buffer circuit 130 is adjustable.

The ADC 140 is used to convert the second intermediate signal SS3 into a digital signal Dout. More specifically, the ADC 140 includes a sampling circuit 142 and a conversion circuit 144. The sampling circuit 142 is used to sample the second intermediate signal SS3 to generate a sampled signal SS4. The conversion circuit 144 is used to convert the sampled signal SS4 into the digital signal Dout.

It should be noted that, in some embodiments, if the driving capability of the second intermediate signal SS3 is sufficient, the buffer circuit 130 can be omitted.

In an alternative embodiment, the receiving module 100 of a transmission interface may include multiple channels, where each channel includes a track-and-hold circuit 120, a buffer circuit 130, and at least one ADC 140. For example, the receiving module 100 of a transmission interface may include 16 channels, and each channel includes 4 ADCs 140.

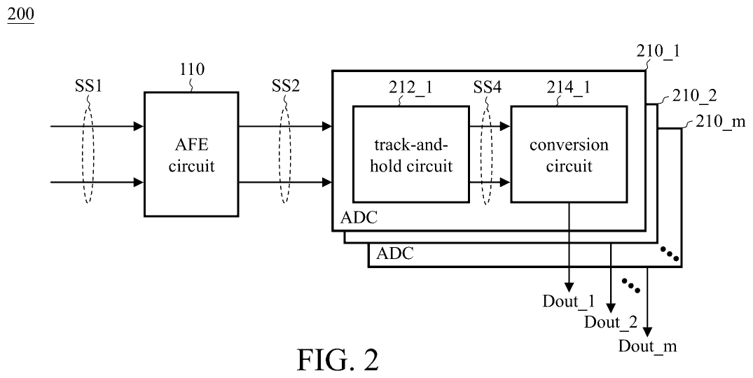

Reference is made to FIG. 2, which is a functional block diagram of the receiving module of a transmission interface according to another embodiment of the present invention. The receiving module 200 of a transmission interface includes the AFE circuit 110 and at least one ADC (the ADC 210_1, the ADC 210_2, . . . , the ADC 210_m, where m is an integer greater than or equal to 1). The ADC 210_k (1≤k≤m) is used to convert the first intermediate signal SS2 into the digital signal Dout_k. More specifically, each ADC 210_k includes a track-and-hold circuit and a conversion circuit. Taking the ADC 210_1 as an example, the track-and-hold circuit 212_1 is used to sample the first intermediate signal SS2 to generate the sampled signal SS4. The conversion circuit 214_1 is coupled to the track-and-hold circuit 212_1 and is configured to convert the sampled signal SS4 into the digital signal Dout 1. Similarly, the ADC 210_2 and the ADC 210_m respectively generate the digital signal Dout_2 and the digital signal Dout_m.

Reference is made to FIG. 1 and FIG. 2. The track-and-hold circuit 120 can be the same as the track-and-hold circuit 212_1. When the receiving module 100 of a transmission interface contains m channels, the track-and-hold circuits 120 from the m channels can be the same as the track-and-hold circuit 212_1, the track-and-hold circuit 212_2 (not shown), . . . , and the track-and-hold circuit 212_m (not shown), respectively. The track-and-hold circuit 212_2 and the track-and-hold circuit 212_m are the track-and-hold circuits of the ADC 210_2 and the ADC 210_m, respectively.

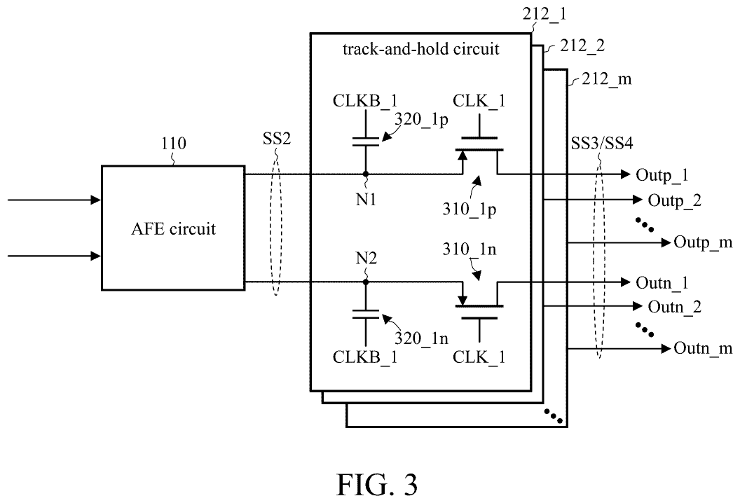

Reference is made to FIG. 3, which is a circuit diagram of the track-and-hold circuit according to an embodiment of the present invention. In the embodiment of FIG. 3, the track-and-hold circuit 212_1 includes a switch 310_1p, a switch 310_1n, a capacitor 320_1p, and a capacitor 320_1n. The track-and-hold circuits 212_2 and 212_m are the same as the track-and-hold circuit 212_1. The output signal Outp_1 and the output signal Outn_1 are the outputs of the track-and-hold circuit 212_1. The output signal Outp_2 and the output signal Outn_2 are the outputs of the track-and-hold circuit 212_2. The output signal Outp_m and the output signal Outn_m are the outputs of the track-and-hold circuit 212_m. These output signals form the second intermediate signal SS3 or the sampled signal SS4.

The track-and-hold circuit 212_1 includes a node N1 and a node N2 electrically connected to the AFE circuit 110. The switch 310_1p and the switch 310_1n are P-channel Metal-Oxide-Semiconductor Field-Effect Transistors (hereinafter referred to as PMOS transistors).

The source of the switch 310_1p is electrically connected to the node N1; the drain of the switch 310_1p is one of the output terminals of the track-and-hold circuit 212_1; the gate of the switch 310_1p receives the clock CLK_1. The source of the switch 310_1n is electrically connected to the node N2; the drain of the switch 310_1n is one of the output terminals of the track-and-hold circuit 212_1; the gate of the switch 310_1n receives the clock CLK_1.

One terminal of the capacitor 320_1p is electrically connected to the node N1; the other terminal of the capacitor 320_1p receives the clock CLKB_1. One terminal of the capacitor 320_1n is electrically connected to the node N2; the other terminal of the capacitor 320_1n receives the clock CLKB_1.

The clock CLK_1 and the clock CLKB_1 are each other's inverted signals. More specifically, when the clock CLK_1 transitions from a low (high) level to a high (low) level, the clock CLKB_1 transitions from a high (low) level to a low (high) level. In this way, the disturbances caused by the clock CLK_1 at the output terminals of the AFE circuit 110 are canceled by the clock CLKB_1, enhancing the overall performance of the receiving module 100 or the receiving module 200 of a transmission interface.

Since the clock CLK_1 and the clock CLKB_1 are each other's inverted signals, the track-and-hold circuit 212_1 can be considered to sample the first intermediate signal SS2 based on the clock CLK_1 and/or the clock CLKB_1 to generate the second intermediate signal SS3 or the sampled signal SS4.

In some embodiments, the capacitance value of the capacitor 320_1p (320_1n) can be designed to be substantially the same as the capacitance value of the gate-source parasitic capacitor of the PMOS transistor of the switch 310_1p (310_1n).

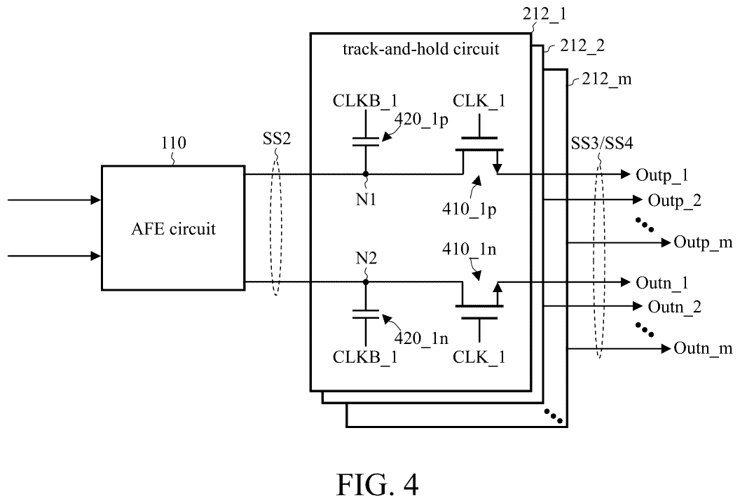

Reference is made to FIG. 4, which is the circuit diagram of the track-and-hold circuit according to another embodiment of the present invention. In the embodiment of FIG. 4, the track-and-hold circuit 212_1 includes the switch 410_1p, the switch 410_1n, the capacitor 420_1p, and the capacitor 420_1n. The track-and-hold circuits 212_2 and 212_m are the same as the track-and-hold circuit 212_1.

The switch 410_1p and the switch 410_1n are N-channel Metal-Oxide-Semiconductor Field-Effect Transistors (hereinafter referred to as NMOS transistors).

The source of the switch 410_1p is one of the output terminals of the track-and-hold circuit 212_1; the drain of the switch 410_1p is electrically connected to the node N1; the gate of the switch 410_1p receives the clock CLK_1. The source of the switch 410_1n is one of the output terminals of the track-and-hold circuit 212_1; the drain of the switch 410_1n is electrically connected to the node N2; the gate of the switch 410_1n receives the clock CLK_1.

One terminal of the capacitor 420_1p is electrically connected to the node N1; the other terminal of the capacitor 420_1p receives the clock CLKB_1. One terminal of the capacitor 420_1n is electrically connected to the node N2; the other terminal of the capacitor 420_1n receives the clock CLKB_1.

In some embodiments, the capacitance value of the capacitor 420_1p (420_1n) can be designed to be substantially the same as the capacitance value of the gate-drain parasitic capacitor of the NMOS transistor of the switch 410_1p (410_1n).

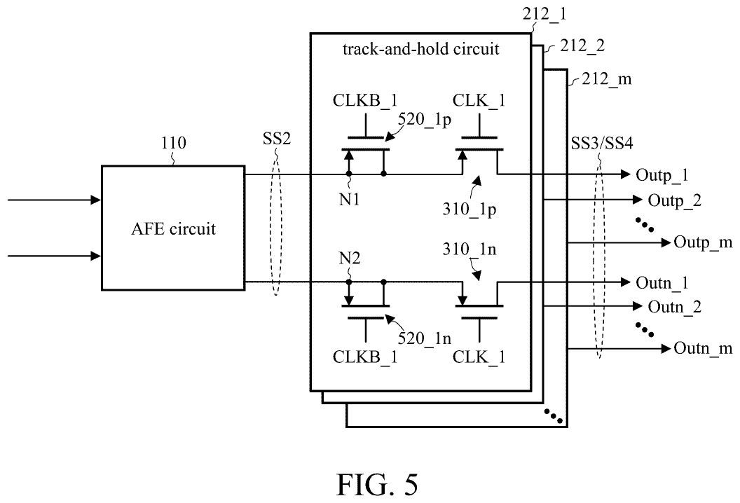

Reference is made to FIG. 5, which is a circuit diagram of the track-and-hold circuit according to another embodiment of the present invention. In the embodiment of FIG. 5, the track-and-hold circuit 212_1 includes the switch 310_1p, the switch 310_1n, a capacitor 520_1p, and a capacitor 520_1n. The track-and-hold circuits 212_2 and 212_m are the same as the track-and-hold circuit 212_1.

The capacitor 520_1p and the capacitor 520_1n are each embodied by a PMOS transistor. The source and the drain of the PMOS transistor are both electrically connected to the node N1 (or N2); the gate of the PMOS transistor receives the clock CLKB_1.

In some embodiments, the aspect ratio of the PMOS transistor of the capacitor 520_1p is substantially equal to half of the aspect ratio of the PMOS transistor of the switch 310_1p, and the aspect ratio of the PMOS transistor of the capacitor 520_1n is substantially equal to half of the aspect ratio of the PMOS transistor of the switch 310_1n. Because the source and drain of the PMOS transistor of the capacitor 520_1p (or 520_1n) are electrically connected to each other, the equivalent capacitance value of the capacitor 520_1p (or 520_1n) is approximately equal to the capacitance value of the gate-source parasitic capacitor of the PMOS transistor of the switch 310_1p (310_1n). Such a design helps the disturbances caused by the clock CLK_1 and the clock CLKB_1 at the node N1 and the node N2 to cancel each other out.

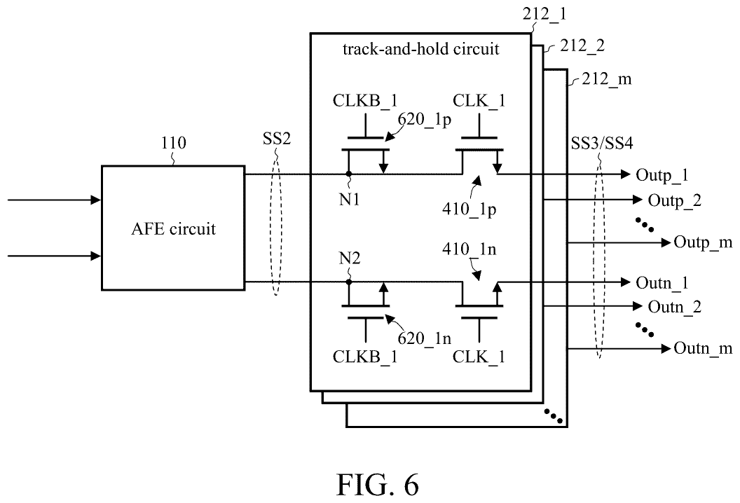

Reference is made to FIG. 6, which is a circuit diagram of the track-and-hold circuit according to another embodiment of the present invention. In the embodiment of FIG. 6, the track-and-hold circuit 212_1 includes the switch 4101p, the switch 410_1n, a capacitor 620_1p, and a capacitor 620_1n. The track-and-hold circuits 212_2 and 212_m are the same as the track-and-hold circuit 212_1.

The capacitor 620_1p and the capacitor 620_1n are each embodied by an NMOS transistor. The source and the drain of the NMOS transistor are both electrically connected to the node N1 (or N2); the gate of the NMOS transistor receives the clock CLKB_1.

In some embodiments, the aspect ratio of the NMOS transistor of the capacitor 620_1p is substantially equal to half of the aspect ratio of the NMOS transistor of the switch 410_1p, and the aspect ratio of the NMOS transistor of the capacitor 620_1n is substantially equal to half of the aspect ratio of the NMOS transistor of the switch 410_1n.

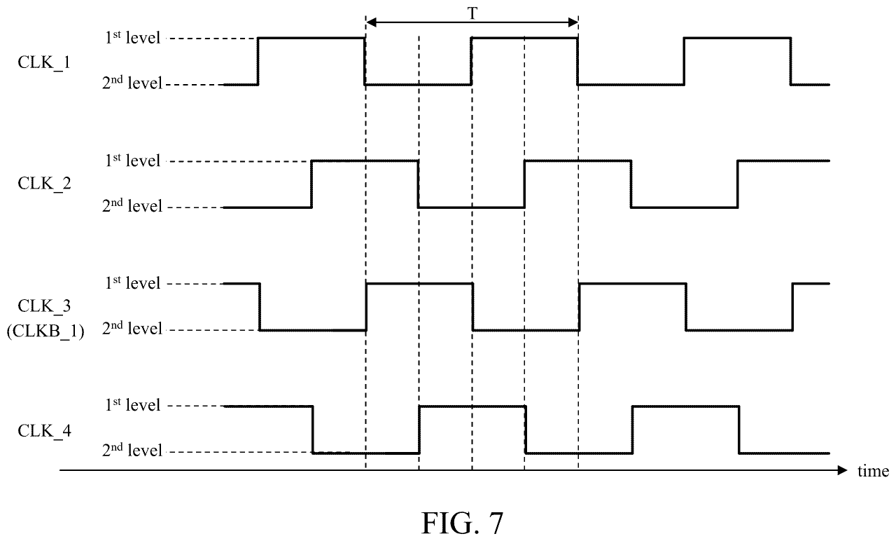

Reference is made to FIG. 7, which shows the waveforms of the clocks according to an embodiment of the present invention. In the embodiment of FIG. 7, assuming m=4, the track-and-hold circuits 212_1, 212_2, 212_3 (not shown), and 2124 operate according to the clocks CLK_1, CLK_2, CLK_3, and CLK_4, respectively, to sample the intermediate signal, for example. The clocks CLK_1, CLK_2, CLK_3, and CLK_4 have the same period (T), but their phases are 90*p degrees (p=0, 1, 2, 3), respectively. In other words, m track-and-hold circuits require m clocks with the same period, and the phase of each clock is 360*p/m degrees (p=0, 1, 2, . . . , m−1).

When the clock CLK_1 (CLK_2, CLK_3, CLK_4) is at the first level, the switches embodied by the NMOS transistor (410_1p, 410_1n) are turned on, and the switches embodied by the PMOS transistor (310_1p, 310_1n) are turned off. When the clock CLK_1 (CLK_2, CLK_3, CLK_4) is at the second level, the switches embodied by the NMOS transistor (410_1p, 410_1n) are turned off, and the switches embodied by the PMOS transistor (3101p, 3101n) are turned on.

The clock CLK_1 and the clock CLK_3 are each other's inverted signals, and the clock CLK_2 and the clock CLK_4 are each other's inverted signals. The generation of a clock's inverted signal is well known to people having ordinary skill in the art, so further elaboration is omitted for brevity.

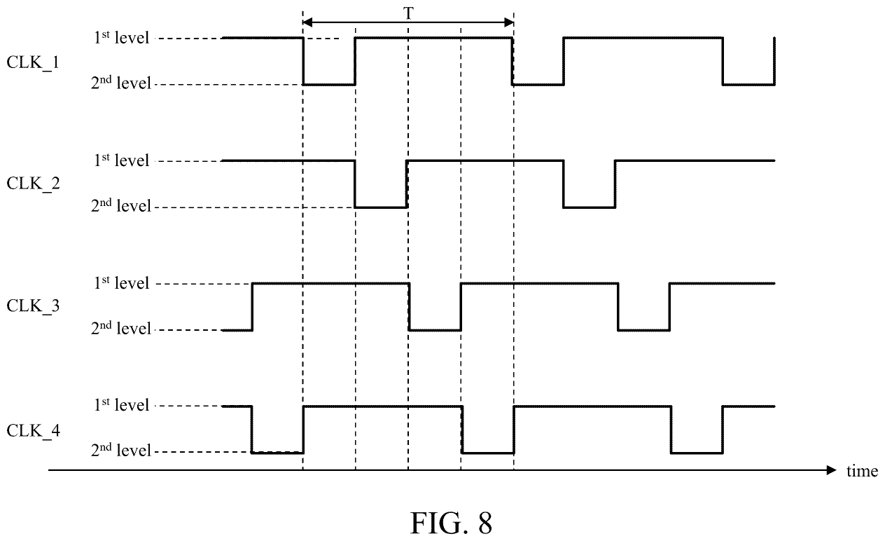

Reference is made to FIG. 8, which shows the waveforms of the clocks according to another embodiment of the present invention. The embodiment of FIG. 8 is similar to the embodiment of FIG. 7 (m=4), but the duty cycle of the clocks in these two embodiments is substantially 50% and 75%, respectively. In other words, the clocks of the present invention are not limited by the duty cycle.

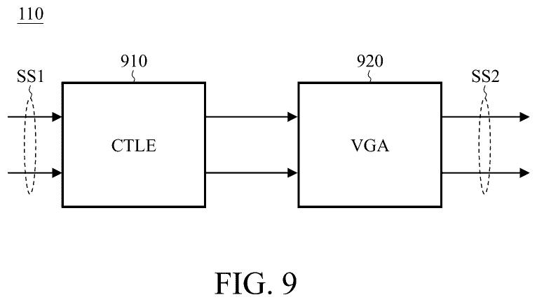

Reference is made to FIG. 9, which is a functional block diagram of the AFE circuit according to an embodiment of the present invention. The AFE circuit 110 includes a CTLE 910 and a VGA 920. The VGA 920 receives the output of the CTLE 910 (i.e., the CTLE 910 is the preceding circuit of the VGA 920).

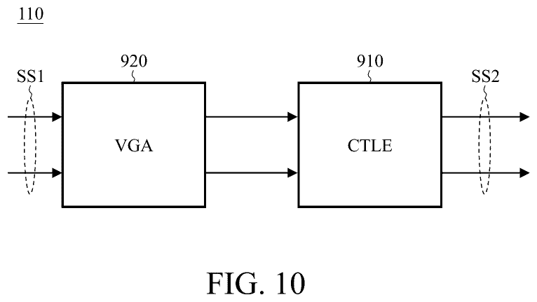

Reference is made to FIG. 10, which is a functional block diagram of the AFE circuit according to another embodiment of the present invention. The AFE circuit 110 includes the CTLE 910 and the VGA 920. The CTLE 910 receives the output of the VGA 920 (i.e., the VGA 920 is the preceding circuit of the CTLE 910).

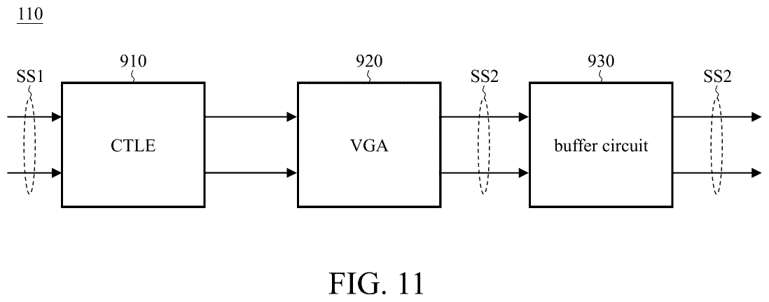

Reference is made to FIG. 11, which is a functional block diagram of the AFE circuit according to another embodiment of the present invention. FIG. 11 is similar to FIG. 9, but in the embodiment of FIG. 11, the AFE circuit 110 further includes a buffer circuit 930.

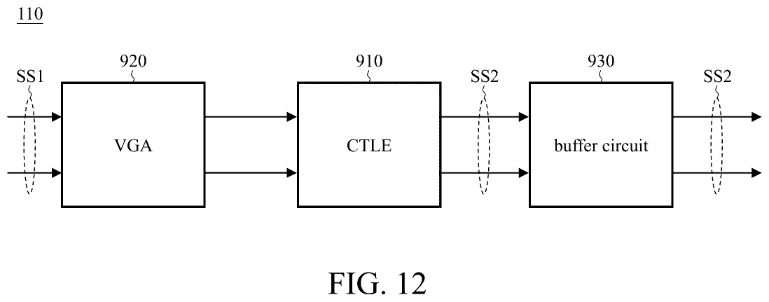

Reference is made to FIG. 12, which is a functional block diagram of the AFE circuit according to another embodiment of the present invention. FIG. 12 is similar to FIG. 10, but in the embodiment of FIG. 12, the AFE circuit 110 further includes the buffer circuit 930.

The buffer circuit 930 not only enhances the driving capability of the output signal of the CTLE 910 or the VGA 920 but also further reduces the disturbance caused by the track-and-hold circuit 120 (or 2121) to the output signal of the CTLE 910 or the VGA 920. In some embodiments, the buffer circuit 930 can be embodied by a source follower.

In other embodiments, the AFE circuit 110 includes one of the CTLE 910 and the VGA 920 but does not include both simultaneously.

Note that the shape, size, and ratio of any element in the disclosed figures are exemplary for understanding, not for limiting the scope of this invention.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A receiving module of a transmission interface, comprising:
an analog front-end (AFE) circuit configured to receive an input signal to generate a first intermediate signal; and
a track-and-hold circuit coupled to the AFE circuit and configured to sample the first intermediate signal according to a first clock to generate a second intermediate signal, and comprising:
at least one first switch coupled to the AFE circuit and turned on or off according to the first clock;
at least one second switch coupled to the AFE circuit and turned on or off according to the first clock;
at least one first capacitor having a first terminal and a second terminal, wherein the first terminal is coupled to the AFE circuit, and the second terminal receives a second clock; and
at least one second capacitor having a third terminal and a fourth terminal, wherein the third terminal is coupled to the AFE circuit, and the fourth terminal receives the second clock;
wherein the first clock and the second clock are each other's inverted signals.

2. The receiving module of claim 1, wherein the at least one first switch is a first P-channel Metal-Oxide-Semiconductor Field-Effect Transistor having a first source, a first drain, and a first gate, wherein the first source is electrically connected to the first terminal, the first drain outputs the second intermediate signal, and the first gate receives the first clock; and the at least one second switch is a second P-channel Metal-Oxide-Semiconductor Field-Effect Transistor having a second source, a second drain, and a second gate, wherein the second source is electrically connected to the third terminal, the second drain outputs the second intermediate signal, and the second gate receives the first clock.

3. The receiving module of claim 2, wherein a capacitance value of the at least one first capacitor is substantially equal to a capacitance value of a gate-source parasitic capacitor of the first P-channel Metal-Oxide-Semiconductor Field-Effect Transistor, and a capacitance value of the at least one second capacitor is substantially equal to a capacitance value of a gate-source parasitic capacitor of the second P-channel Metal-Oxide-Semiconductor Field-Effect Transistor.

4. The receiving module of claim 2, wherein the at least one first capacitor is embodied by a third P-channel Metal-Oxide-Semiconductor Field-Effect Transistor having a third source, a third drain, and a third gate, wherein the third source is electrically connected to the first terminal, the third drain is electrically connected to the first terminal, and the third gate receives the second clock; and the at least one second capacitor is embodied by a fourth P-channel Metal-Oxide-Semiconductor Field-Effect Transistor having a fourth source, a fourth drain, and a fourth gate, wherein the fourth source is electrically connected to the third terminal, the fourth drain is electrically connected to the third terminal, and the fourth gate receives the second clock.

5. The receiving module of claim 4, wherein an aspect ratio of the third P-channel Metal-Oxide-Semiconductor Field-Effect Transistor is substantially equal to half of an aspect ratio of the first P-channel Metal-Oxide-Semiconductor Field-Effect Transistor, and an aspect ratio of the fourth P-channel Metal-Oxide-Semiconductor Field-Effect Transistor is substantially equal to half of an aspect ratio of the second P-channel Metal-Oxide-Semiconductor Field-Effect Transistor.

6. The receiving module of claim 1, wherein the at least one first switch is a first N-channel Metal-Oxide-Semiconductor Field-Effect Transistor having a first source, a first drain, and a first gate, wherein the first source outputs the second intermediate signal, the first drain is electrically connected to the first terminal, and the first gate receives the first clock; and the at least one second switch is a second N-channel Metal-Oxide-Semiconductor Field-Effect Transistor having a second source, a second drain, and a second gate, wherein the second source outputs the second intermediate signal, the second drain is electrically connected to the third terminal, and the second gate receives the first clock.

7. The receiving module of claim 6, wherein a capacitance value of the at least one first capacitor is substantially equal to a capacitance value of a gate-drain parasitic capacitor of the first N-channel Metal-Oxide-Semiconductor Field-Effect Transistor, and a capacitance value of the at least one second capacitor is substantially equal to a capacitance value of a gate-drain parasitic capacitor of the second N-channel Metal-Oxide-Semiconductor Field-Effect Transistor.

8. The receiving module of claim 6, wherein the at least one first capacitor is embodied by a third N-channel Metal-Oxide-Semiconductor Field-Effect Transistor having a third source, a third drain, and a third gate, wherein the third source is electrically connected to the first terminal, the third drain is electrically connected to the first terminal, and the third gate receives the second clock; and the at least one second capacitor is embodied by a fourth N-channel Metal-Oxide-Semiconductor Field-Effect Transistor having a fourth source, a fourth drain, and a fourth gate, wherein the fourth source is electrically connected to the third terminal, the fourth drain is electrically connected to the third terminal, and the fourth gate receives the second clock.

9. The receiving module of claim 8, wherein an aspect ratio of the third N-channel Metal-Oxide-Semiconductor Field-Effect Transistor is substantially equal to half of an aspect ratio of the first N-channel Metal-Oxide-Semiconductor Field-Effect Transistor, and an aspect ratio of the fourth N-channel Metal-Oxide-Semiconductor Field-Effect Transistor is substantially equal to half of an aspect ratio of the second N-channel Metal-Oxide-Semiconductor Field-Effect Transistor.

10. The receiving module of claim 1 further comprising an analog-to-digital converter (ADC) configured to convert the second intermediate signal into a digital signal, wherein the ADC comprises:
a sampling circuit coupled to the track-and-hold circuit and configured to sample the second intermediate signal to generate a sampled signal; and
a conversion circuit coupled to the sampling circuit and configured to convert the sampled signal into the digital signal.

11. The receiving module of claim 10 further comprising:
a buffer circuit coupled to the track-and-hold circuit and the ADC and configured to enhance a driving capability of the second intermediate signal.

12. The receiving module of claim 1 further comprising:
M track-and-hold circuits, each of which is substantially identical to the track-and-hold circuit and samples the first intermediate signal according to one of M clocks, where M is an integer greater than or equal to one;
wherein a phase of the first clock is 0 degrees, and M phases of the M clocks are respectively 360*p/(M+1), where p is an integer greater than or equal to 1 and less than or equal to M.

13. A receiving module of a transmission interface, comprising:
an analog front-end (AFE) circuit configured to receive an input signal to generate a first intermediate signal; and
an analog-to-digital converter (ADC) coupled to the AFE circuit and comprising:
a track-and-hold circuit configured to sample the first intermediate signal according to a first clock to generate a sampled signal; and
a conversion circuit coupled to the track-and-hold circuit and configured to convert the sampled signal into a digital signal;
wherein the track-and-hold circuit comprises:
at least one first switch coupled to the AFE circuit and turned on or off according to the first clock;
at least one second switch coupled to the AFE circuit and turned on or off according to the first clock;
at least one first capacitor having a first terminal and a second terminal, wherein the first terminal is coupled to the AFE circuit, and the second terminal receives a second clock; and
at least one second capacitor having a third terminal and a fourth terminal, wherein the third terminal is coupled to the AFE circuit, and the fourth terminal receives the second clock;
wherein the first clock and the second clock are each other's inverted signals.

14. The receiving module of claim 13, wherein the at least one first switch is a first P-channel Metal-Oxide-Semiconductor Field-Effect Transistor having a first source, a first drain, and a first gate, wherein the first source is electrically connected to the first terminal, the first drain outputs the sampled signal, and the first gate receives the first clock; and the at least one second switch is a second P-channel Metal-Oxide-Semiconductor Field-Effect Transistor having a second source, a second drain, and a second gate, wherein the second source is electrically connected to the third terminal, the second drain outputs the sampled signal, and the second gate receives the first clock.

15. The receiving module of claim 14, wherein a capacitance value of the at least one first capacitor is substantially equal to a capacitance value of a gate-source parasitic capacitor of the first P-channel Metal-Oxide-Semiconductor Field-Effect Transistor, and a capacitance value of the at least one second capacitor is substantially equal to a capacitance value of a gate-source parasitic capacitor of the second P-channel Metal-Oxide-Semiconductor Field-Effect Transistor.

16. The receiving module of claim 14, wherein the at least one first capacitor is embodied by a third P-channel Metal-Oxide-Semiconductor Field-Effect Transistor having a third source, a third drain, and a third gate, wherein the third source is electrically connected to the first terminal, the third drain is electrically connected to the first terminal, and the third gate receives the second clock; and the at least one second capacitor is embodied by a fourth P-channel Metal-Oxide-Semiconductor Field-Effect Transistor having a fourth source, a fourth drain, and a fourth gate, wherein the fourth source is electrically connected to the third terminal, the fourth drain is electrically connected to the third terminal, and the fourth gate receives the second clock.

17. The receiving module of claim 16, wherein an aspect ratio of the third P-channel Metal-Oxide-Semiconductor Field-Effect Transistor is substantially equal to half of an aspect ratio of the first P-channel Metal-Oxide-Semiconductor Field-Effect Transistor, and an aspect ratio of the fourth P-channel Metal-Oxide-Semiconductor Field-Effect Transistor is substantially equal to half of an aspect ratio of the second P-channel Metal-Oxide-Semiconductor Field-Effect Transistor.

18. The receiving module of claim 13, wherein the at least one first switch is a first N-channel Metal-Oxide-Semiconductor Field-Effect Transistor having a first source, a first drain, and a first gate, wherein the first source outputs the sampled signal, the first drain is electrically connected to the first terminal, and the first gate receives the first clock; and the at least one second switch is a second N-channel Metal-Oxide-Semiconductor Field-Effect Transistor having a second source, a second drain, and a second gate, wherein the second source outputs the sampled signal, the second drain is electrically connected to the third terminal, and the second gate receives the first clock.

19. The receiving module of claim 18, wherein a capacitance value of the at least one first capacitor is substantially equal to a capacitance value of a gate-drain parasitic capacitor of the first N-channel Metal-Oxide-Semiconductor Field-Effect Transistor, and a capacitance value of the at least one second capacitor is substantially equal to a capacitance value of a gate-drain parasitic capacitor of the second N-channel Metal-Oxide-Semiconductor Field-Effect Transistor.

20. The receiving module of claim 18, wherein the at least one first capacitor is embodied by a third N-channel Metal-Oxide-Semiconductor Field-Effect Transistor having a third source, a third drain, and a third gate, wherein the third source is electrically connected to the first terminal, the third drain is electrically connected to the first terminal, and the third gate receives the second clock; and the at least one second capacitor is embodied by a fourth N-channel Metal-Oxide-Semiconductor Field-Effect Transistor having a fourth source, a fourth drain, and a fourth gate, wherein the fourth source is electrically connected to the third terminal, the fourth drain is electrically connected to the third terminal, and the fourth gate receives the second clock.
